(19) United States
(12) Patent Application Publication
(10) Pub. No.: US 2020/0143272 A1
(43) Pub. Date: May 7, 2020

(54) TERMINAL RULE OPERATION DEVICE AND METHOD

(71) Applicant: Alibaba Group Holding Limited, George Town (KY)

(72) Inventors: Jupeng Xia, Hangzhou (CN); Xueyao Gao, Hangzhou (CN); Shaoqing MA, Hangzhou (CN); Bei Tian, Hangzhou (CN); Chongmin Huang, Hangzhou (CN)

(73) Assignee: Alibaba Group Holding Limited, George Town (KY)

(21) Appl. No.: 16/725,728

(22) Filed: Dec. 23, 2019

Related U.S. Application Data
(63) Continuation of application No. 16/254,493, filed on Jan. 22, 2019.
Application No. 16/254,493 is a continuation of application No. PCT/CN2017/093212, filed on Jul. 17, 2017.

(30) Foreign Application Priority Data
Jul. 22, 2016 (CN) 201610587576.1

(51) Int. Cl. G06N 5/04; G06F 16/901; G06N 5/00; G06N 5/02; H04L 12/24

(52) U.S. Cl. CPC G06N 5/046; G06F 16/9027; H04L 41/0893; G06N 5/025; H04L 41/16; G06N 5/003

(57) ABSTRACT

A rule operation request associated with a service is received by a terminal. A rule corresponding to the rule operation request is obtained from a rule set associated with the service, where the rule set has been previously obtained from the server based on at least one of a device identifier or a user identifier corresponding to the terminal. A rule tree is generated based on the rule. An operation result of the rule is determined based on the rule tree and service data related to the rule.

### CROSS-REFERENCE TO RELATED APPLICATIONS

This application is a continuation of U.S. patent application Ser. No. 16/254,493, filed Jan. 22, 2019, which is a continuation of PCT Application No. PCT/CN2017/093212, filed on Jul. 17, 2017, which claims priority to Chinese Patent Application No. 201610587576.1, filed on Jul. 22, 2016, and each application is hereby incorporated by reference in its entirety.

### TECHNICAL FIELD

The present application relates to the field of computer technologies, and in particular, to a terminal rule engine device and a terminal rule operation method.

### BACKGROUND

With the rapid development of computer technologies and Internet technologies, many services can be executed online. Normal execution of the online services depends on predetermined service rules, for example, rules for a payment service, rules for a risk control service, etc.

In the existing technology, rules are operated in a server, and the operated rules are globally applied to all terminals corresponding to the server. A rule operation result of the server is sent to each terminal corresponding to the server, and each terminal determines how to perform subsequent service processing based on the rule operation result.

However, the global application of the rule operation method in the existing technology leads to relatively high risk when performing rule operations or updating operations, causing negative effects on each terminal once a problem occurs.

### SUMMARY

Implementations of the present application provide a terminal rule engine device, to alleviate a problem that the risk is relatively high during rule operation or rule update due to the global application of the rule operation method in the existing technology.

Implementations of the present application further provide a terminal rule operation method, to alleviate a problem that the risk is relatively high during rule operation or rule update due to a global application of a rule operation method in the existing technology.

The following technical solutions are adopted in the implementations of the present application.

The implementations of the present application provide a terminal rule engine device. The device is located on a terminal and includes an interface module, a management module, and an operation module. The interface module receives a rule operation request of a service; the management module manages a rule set of the service obtained from a server based on a device identifier and/or a user identifier corresponding to the terminal; and the operation module, in response to the request received by the interface module, obtains a rule corresponding to the request from the rule set managed by the management module, generates a rule tree based on the obtained rule, obtains service data related to the rule tree, and determines an operation result of the rule based on the rule tree and the service data.

The implementations of the present application further provide a terminal rule operation method, including the following: receiving, by a terminal, a rule operation request of a service; obtaining, by the terminal, a rule corresponding to the request from a rule set of the service, where the rule set is obtained from a server based on a device identifier and/or a user identifier corresponding to the terminal; generating, by the terminal, a rule tree based on the obtained rule, and obtaining service data related to the rule tree; and determining, by the terminal and based on the rule tree, the service data and an operation result of the rule.

At least one of the previous technical solutions used in the implementations of the present application can achieve the following beneficial effects: The rule engine device is deployed in the terminal to manage a device-level or user-level rule set by using the device identifier and/or the user identifier of the terminal. Therefore, a rule in the rule set is operated in the terminal, and rule operation or rule update is separately performed in different terminals, to reduce the risk during rule operation or rule update, thereby partially or totally alleviating the problem in the existing technology.

### BRIEF DESCRIPTION OF DRAWINGS

The accompanying drawings described here are intended to provide a further understanding of the present application, and constitute a part of the present application. The illustrative implementations of the present application and descriptions thereof are intended to describe the present application, and do not constitute limitations on the present application. In the accompanying drawings:

FIG. 1 is a schematic structural diagram illustrating a terminal rule engine device, according to an implementation of the present application;

FIG. 2 is a schematic structural diagram illustrating a rule tree, according to an implementation of the present application;

FIG. 3 is a first detailed schematic structural diagram illustrating the terminal rule engine device in FIG. 1, according to an implementation of the present application;

FIG. 4 is a second detailed schematic structural diagram illustrating the terminal rule engine device in FIG. 1, according to an implementation of the present application;

FIG. 5 is a third detailed schematic structural diagram illustrating the terminal rule engine device in FIG. 1, according to an implementation of the present application;

FIG. 6 is a schematic flowchart illustrating a terminal rule operation method, according to an implementation of the present application; and

FIG. 7 is a flowchart illustrating an example of a computer-implemented method for processing a rule operation, according to an implementation of the present disclosure.

### DESCRIPTION OF IMPLEMENTATIONS

To make the objectives, technical solutions, and advantages of the present application clearer, the following clearly and comprehensively describes the technical solutions of the present application with reference to specific implementations and accompanying drawings of the present application. Apparently, the described implementations are merely some rather than all of the implementations of the present application. All other implementations obtained by a person of ordinary skill in the art based on the implementations of the present application without creative efforts shall fall within the protection scope of the present application.

As described in the background, there is a high risk in the rule operation method in the existing technology, and there are more problems than this in the existing technology. Because a rule is operated in a server and a large number of calculation resources of the server needs to be consumed, the server may work under heavy burden; processes of operating rules for a plurality of terminals by the server can affect each other, which increases a risk to service stability; a rule operation result of the server globally affects a service, therefore, when there is a problem with a rule of the server or an operation error occurs during rule operation, an unreliable rule operation result is obtained, correspondingly causing global negative effects on the service.

The solutions of the present application provide a terminal rule engine device disposed on a terminal. A rule can be operated on each terminal instead of the server, thereby partially or totally alleviating the previous problem. The solutions of the present application are described below.

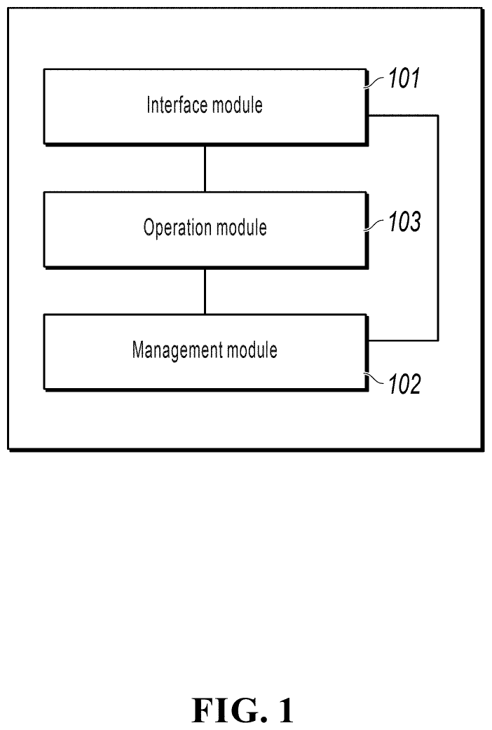

FIG. 1 is a schematic structural diagram illustrating a terminal rule engine device, according to an implementation of the present application. The device is located on a terminal.

In this implementation of the present application, the terminal can be a device such as a mobile phone, a tablet computer, a smart watch, a smart band, an in-vehicle mobile station, or a personal computer.

The terminal has a server corresponding to the terminal, and the server can usually be a server of one or more applications (such as a mobile phone App) installed in the terminal. Each server can correspond to a plurality of terminals. All the terminals can have respective terminal rule engine devices, and can independently operate service rules.

The device in FIG. 1 includes an interface module 101, a management module 102, and an operation module 103.

The interface module 101 receives a rule operation request of a service.

The management module 102 manages a rule set of the service obtained from a server, based on a device identifier and/or a user identifier corresponding to the terminal.

The operation module 103, in response to the request received by the interface module 101, obtains a rule corresponding to the request from the rule set managed by the management module 102, generates a rule tree based on the obtained rule, obtains service data related to the rule tree, and determines an operation result of the rule based on the rule tree and the service data.

In this implementation of the present application, service content is not limited, and can be any service that can be executed online, for example, an e-commerce service, a finance service, a communication service, a risk control service, and a video surveillance service. The services can independently serve a user, or can assist each other in serving the user.

In this implementation of the present application, the terminal rule engine device can belong to a type of service and used for only this type of service, or can be used for more than one type of service.

A related functional module of the service can send the rule operation request by using the interface module 101 to invoke the terminal rule engine device to operate a corresponding rule. In addition to receiving the rule operation request, interaction between the terminal rule engine device and another device can be performed by using the interface module 101, for example, returning a rule operation result, granting an invoking permission, or obtaining related service data.

In this implementation of the present application, the terminal rule engine device can obtain the rule set of the service from the server. An acquisition process can be actively initiated by the terminal rule engine device, for example, the terminal rule engine device requests to obtain the rule set from the server. Alternatively, an acquisition process can be actively initiated by the server, for example, the server sends the rule set to the terminal rule engine device. In practice, to improve rule operation efficiency, the acquisition process of the rule set of the service is usually performed in advance. In this case, when there is a need to operate a rule, the rule set has been stored in the terminal, and a corresponding rule in the rule set can be directly operated without interacting with the server.

Further, the acquisition process can be performed by the management module 102, or can be performed by another module of the terminal rule engine device. Management on the rule set performed by the management module 102 can include updating, maintaining, and managing the rule set, making a decision on a rule that should be operated, etc. In addition to the rule set, the management module 102 can manage other data related to the terminal rule engine device, for example, the service data related to the rule tree.

In this implementation of the present application, terminals not only can independently operate rules, but also can operate rules differently or operate different rules even for a same service. The difference can be implemented based on a difference between device identifiers and/or user identifiers corresponding to different terminals.

For example, the server can provide different rule sets for terminals based on different device identifiers and/or user identifiers provided by the terminals.

For another example, the server can provide a same rule set for terminals, but the management module 102 and the operation module 103 of each terminal can manage and operate the rule set differently based on a device identifier and/or a user identifier corresponding to the terminal. For example, the management module 102 and the operation module 103 only operate a rule in the rule set that matches the device identifier and/or the user identifier corresponding to the terminal.

In this implementation of the present application, the representation form of a rule in the rule set is not limited. The rule can be represented in a code form (such as a script statement or a regular expression), can be represented in a text form (such as a pseudocode), or can be represented in a special data structure form (such as a tree, a linked list, or a graph), etc.

In this implementation of the present application, a rule is operated in a form of a rule tree. The operation module 103 can generate the rule tree based on a rule to be operated in the rule set, to operate the rule by using the rule tree. As described above, the rule in the rule set can be represented in the form of the rule tree. In this case, the operation module 103 does not need to generate the rule tree, but directly obtains the corresponding rule tree from the rule set to operate the rule by using the rule tree.

It is worthwhile to note that the rule is operated in the form of the rule tree due to consideration of the following two points.

First, a structure of the rule tree is hierarchical, orderly, and visible, and is easy to split. These features can help an R&D personnel, an O&M personnel, or a predetermined machine, to logically manage, analyze, and adjust a rule, thereby improving R&D and O&M efficiency and reducing R&D and O&M costs. For example, the rule can be conveniently managed by using the rule tree, and the rule can be adjusted at a fine granularity through node location switching, reorganization, etc., to optimize the rule, and further help improve rule operation efficiency and the specific degree of the rule.

Second, rule operation efficiency is relatively high by using the rule tree because data on each node in the rule tree needs to be read during rule operation, and a hierarchical structure of the rule tree cooperates with a pointer of a non-leaf node to effectively improve a speed of reading the data on each node, so that rule operation efficiency can be relatively high.

In this implementation of the present application, not only the rule tree but also the service data related to the rule tree needs to participate in rule operation, and the service data reflects a service scenario corresponding to a rule that needs to be currently operated. The service data related to the rule tree can be directly obtained by the management module 102 or the operation module 103 from a related functional module of the service. In the former case, the operation module 103 can obtain the service data related to the rule tree from the management module 102 without directly interacting with the related functional module of the service, to help improve security of the operation module 103.

It is worthwhile to note that the method for connecting the modules in FIG. 1 is merely an example, and is not intended to limit the present application. The modules can be connected in another method, provided that the modules can communicate with each other directly or indirectly.

In the previous solution, the rule engine device is deployed in the terminal to manage a device-level rule set and/or a user level rule set by using the device identifier and/or the user identifier of the terminal. Therefore, a rule in the rule set is operated in the terminal, and rule operation or rule update is separately performed in different terminals, to reduce the risk during rule operation or rule update, thereby partially or totally alleviating the problem of the high risk in the existing technology.

In addition, by using the previous solution, other problems in the existing technology can be partially or totally alleviated. Because tasks of operating rules are transferred from the server to terminals, consumption of calculation resources of the server can also be reduced, thereby relieving burden of the server. Because the terminals can independently operate rules and usually does not affect each other, a risk in service stability can be reduced. In addition, a rule operation result of each terminal affects only the terminal. Therefore, even if an unreliable rule operation result is obtained when there is a problem with a terminal rule or an operation error occurs during rule operation, the unreliable rule operation result usually causes negative effects on a service of the terminal but does not affect the other terminals.

Based on the previous solution, this implementation of the present application further provides some specific implementation solutions and extended solutions of the previous solution, which are as described below.

Each module in FIG. 1 can be further subdivided into submodules, and each submodule obtained through subdivision can implement some functions of the module corresponding to the submodule.

In this implementation of the present application, the operation module 103 can include a rule tree calculation submodule configured to generate and calculate a rule tree. That the operation module 103 generates a rule tree based on the obtained rule can include the following: the rule tree calculation submodule determines an expression and/or a logical operator for reflecting the rule based on the obtained rule, and generates the rule tree based on the deterministic expression and/or logical operator.

In this implementation of the present application, the deterministic expression can be used to reflect a determining condition in the rule, and the determined logical operator can be used to perform logic combination on a plurality of determining conditions. The expression includes but is not limited to a logical expression, and a value of the expression is usually TRUE or FALSE. The logical operator includes but is not limited to logical operators AND, OR, NOT, and XOR.

It is worthwhile to note that the expression and the logical operator are example elements of the rule tree. In practice, the rule tree can be formed by using texts or other characters.

Further, the rule tree can be formed in a plurality of methods. Considering calculation efficiency, a leaf node in the rule tree can be the deterministic expression, and a non-leaf node in the rule tree can be the determined logical operator, to achieve relatively high calculation efficiency.

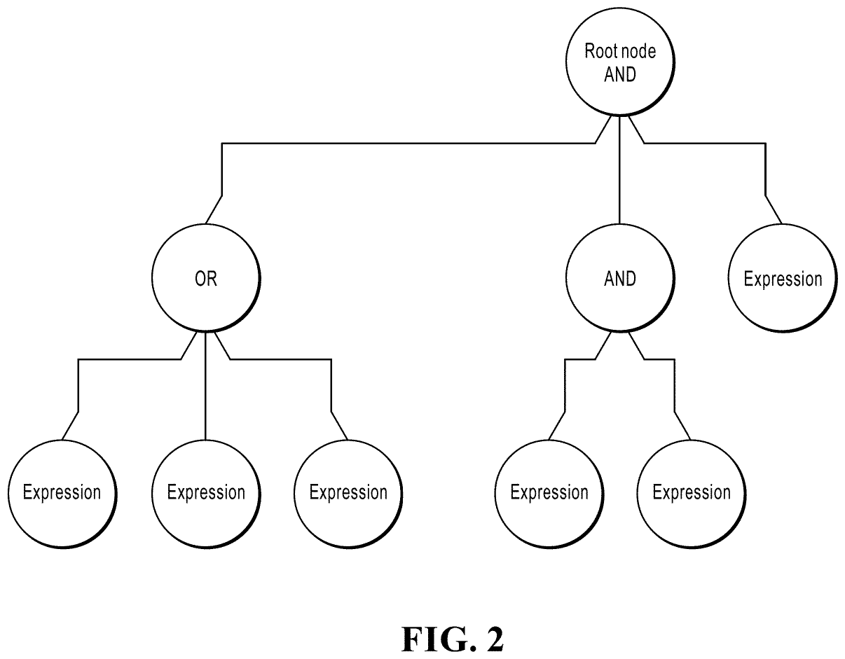

For ease of understanding, an implementation of the present application provides a schematic structural diagram illustrating a rule tree, as shown in FIG. 2.

The rule tree in FIG. 2 is a multi-branch tree, and the multi-branch tree includes three layers. A first layer includes one root node (belonging to a non-leaf node), a second layer includes two non-leaf nodes and one leaf node, and a third layer includes five leaf nodes. The root node is a logical operator “AND” and the two non-leaf nodes at the second layer are respectively a logical operator “OR” and a logical operator “AND”.

It is worthwhile to note that the structure of the rule tree in FIG. 2 is merely an example. The number of layers and branches, the specific expression or logical operator of each node in the rule tree, etc are not limited in the present application.

Further, when a rule tree is calculated, the rule tree needs to be calculated based on a specific structure of the rule tree. The rule tree in FIG. 2 is used as an example. That the operation module 103 determines an operation result of the rule based on the rule tree and the service data can include the following: the operation module performs post-order traversal on the rule tree, calculates a value of a root node in the rule tree in the post-order traversal process based on the service data, and determines a calculation result as the operation result of the rule. The operation result is usually TRUE or FALSE. Certainly, in practice, the operation result is possibly not a logical operation result. For example, the operation result can be a value used to represent one of two or more cases.

It is worthwhile to note that use of the post-order traversal here matches the previous rule tree structure (the leaf node is an expression and the non-leaf node is a logical operator), and matching between the two brings the following advantages:

Determining conditions (expressions) corresponding to rules are distributed at branch ends of the rule tree. It is very clear how to perform logic combination on the determining conditions, and the combination is very orderly (logic combination is performed on all subnodes of each parent node, and logic combination on nodes closer to the branch ends has a higher priority). Correspondingly, post-order traversal is performed when the operation result of the rule is determined, and the traversal is performed from the branch end. A value of logic combination close to the branch end is preferably calculated, and the traversal is performed from bottom to up until the value of the root end is calculated. This satisfies an expected priority sequence, and there is no need to add additional logic to interfere with the traversal, thereby helping efficiently determine the operation result.

In this implementation of the present application, in addition to the post-order traversal, the rule tree can be calculated based on in-order traversal or pre-order traversal. However, in the latter case, efficiency of determining the operation result of the rule is lower than that in the post-order traversal. In addition, the structure of the rule tree and the meaning of each node also possibly change. To be specific, the leaf node is unnecessarily an expression, the non-leaf node is unnecessarily a logical operator, and the calculation result of the root node is unnecessarily determined as the operation result of the rule.

In this implementation of the present application, to calculate the rule tree, a value of an expression included in the rule tree needs to be calculated. The operation module 103 can further include an expression calculation submodule configured to calculate a value of an expression. The service data related to the rule tree includes service data needed for calculating the expression. That the operation module 103 calculates a value of a root node in the rule tree can include the following: the expression calculation submodule calculates a value of each expression based on the obtained service data needed for calculating the expression, and the rule tree calculation submodule calculates the value of the root node in the rule tree in the post-order traversal process, based on the value of each expression calculated by the expression calculation submodule and the determined logical operator.

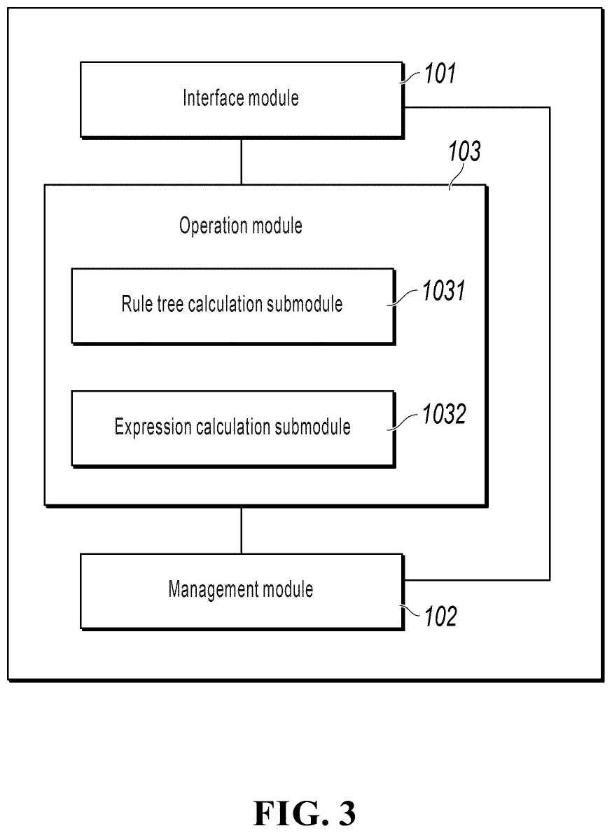

Based on the previous analysis of the submodule of the operation module 103, as shown in FIG. 3, an implementation of the present application provides a first detailed schematic structural diagram illustrating the terminal rule engine device in FIG. 1.

The operation module 103 in FIG. 3 includes a rule tree calculation submodule 1031 and an expression calculation submodule 1032.

In practice, submodules of the operation module 103 are not limited to the two submodules in FIG. 3. Some other submodules that can be included in the operation module 103 are analyzed below.

In this implementation of the present application, after determining the operation result of the rule, the operation module 103 can return the operation result to a requester. Further, to facilitate analysis of the operation result, the operation module 103 can further generate and output operation information related to the operation result. The operation information can be a traversal path used when the rule tree is calculated and each intermediate result.

Therefore, the operation module 103 can further include a result path-tracing submodule configured to complete the operation in the previous paragraph. The result path-tracing submodule records a tracing path of the calculation result to output corresponding operation information. In practice, the information provided by the result path-tracing submodule can help an R&D personnel or an O&M personnel monitor a rule operation status, and predict or locate a rule operation problem, thereby helping improve the terminal rule engine.

In this implementation of the present application, based on the previous analysis, it can be seen that the rule tree calculation submodule 1031 and the expression calculation module 1032 share most calculation tasks during rule operation. In practice, some optimization algorithms can be used to optimize an actual process of executing these calculation tasks, to improve calculation efficiency. To facilitate optimization of a function of a submodule, the operation module 103 can further include a dedicated optimization submodule.

For example, the operation module 103 can further include a tree optimization submodule, and the tree optimization submodule optimizes the rule tree calculation submodule by using an optimization algorithm.

For another example, the operation module 103 can further include an expression optimization submodule, and the expression optimization submodule optimizes the expression calculation submodule by using an optimization algorithm.

In this implementation of the present application, the previous optimization operation can be performed offline or can be performed online. For example, the optimization submodule (the tree optimization submodule or the expression optimization submodule) can be connected to a cloud to directly obtain a latest optimization algorithm from the cloud, thereby optimizing the calculation submodule (the rule tree calculation submodule 1031 or the expression calculation module 1032); or can upload historical data or real-time data for rule operation to a cloud, and the cloud analyzes the data and then provides an appropriate optimization algorithm for the optimization submodule, thereby optimizing the calculation submodule; and so on.

The optimization submodule can make it easier to improve and extend the calculation submodule. In addition, the optimization submodule also reduces direct interaction with the calculation submodule to some extent, thereby helping the calculation submodule focus on completion of the calculation task, and also helping improve security of the calculation submodule.

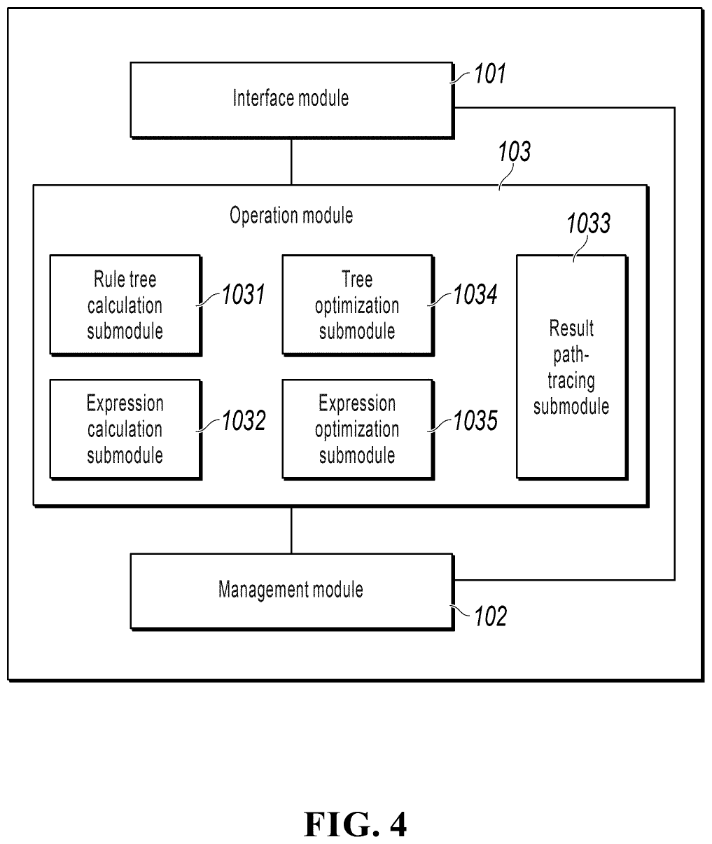

Based on the previous analysis of the submodule of the operation module 103, as shown in FIG. 4, an implementation of the present application further provides a second detailed schematic structural diagram illustrating the terminal rule engine device in FIG. 1 based on FIG. 3.

Compared with FIG. 3, the operation module 103 in FIG. 4 further includes a result path-tracing submodule 1033, a tree optimization submodule 1034, and an expression optimization submodule 1035.

In this implementation of the present application, as mentioned above, the management module 102 can be responsible for updating the rule set in addition to managing the existing rule set. The management module 102 further obtains update data in the rule set from the server based on the device identifier and/or the user identifier corresponding to the terminal. Further, data that can be managed by the management module 102 is not limited to the existing rule set and the update data in the rule set. For example, the management module 102 can further manage the obtained service data related to the rule tree. The service data can be obtained by using corresponding data acquisition interfaces, as such, the management module 102 can manage these data acquisition interfaces together.

In this implementation of the present application, similar to the operation module 103, the management module 102 can also be subdivided into submodules based on different functions of the management module 102. Based on the previous analysis of the functions of the management module 102, a corresponding submodule subdivision method is provided as an example.

The management module 102 can include a data acquisition interface management submodule and a rule set management submodule. The data acquisition interface management submodule manages the service data related to the rule tree, and the rule set management submodule manages the rule set.

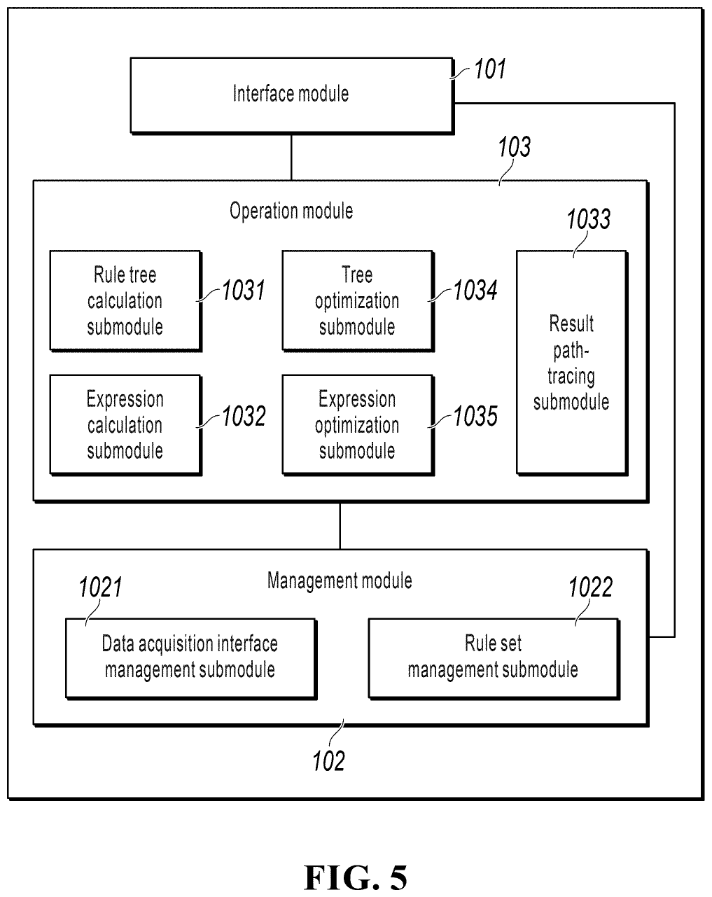

Correspondingly, as shown in FIG. 5, an implementation of the present application further provides a third detailed schematic structural diagram illustrating the terminal rule engine device in FIG. 1 based on FIG. 4.

Compared with FIG. 4, the management module 102 in FIG. 5 includes a data acquisition interface management submodule 1021 and a rule set management submodule 1022.

A structure of the terminal rule engine device is enumerated above, and three detailed structures based on the structure are used as an example. Certainly, the structure and the detailed structure of the terminal rule engine device are not limited to the previous example. The module division method and the submodule division method can also be changed, provided that functions of the terminal rule engine device can be implemented.

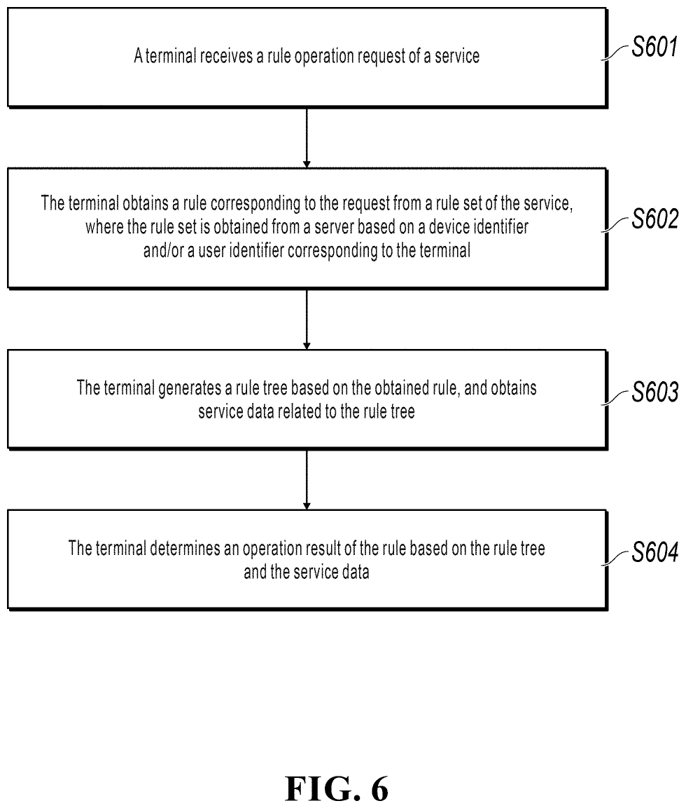

The terminal rule engine device provided in the implementations of the present application is described above in detail. Based on the same idea, as shown in FIG. 6, the implementations of the present application further provide a terminal rule operation method.

FIG. 6 is a schematic flowchart illustrating a terminal rule operation method, according to an implementation of the present application. The method can be performed by a terminal, and can be specifically performed by the previous terminal rule engine device located on the terminal or another device with a similar function.

A procedure shown in FIG. 6 can include the following steps:

S601. A terminal receives a rule operation request of a service.

S602. The terminal obtains a rule corresponding to the request from a rule set of the service, where the rule set is obtained from a server based on a device identifier and/or a user identifier corresponding to the terminal.

S603. The terminal generates a rule tree based on the obtained rule, and obtains service data related to the rule tree.

S604. The terminal determines an operation result of the rule based on the rule tree and the service data.

The method provided in the present application is corresponding to the device provided in the present application, and the method also has beneficial technical effects similar to those of the device. Because the beneficial technical effects of the device have been described above in detail, the beneficial technical effects of the method are omitted here for simplicity.

Based on the method, this implementation of the present application further provides some specific implementation solutions and extended solutions of the method. The solutions are analyzed in detail in the description of the previous device, and therefore only simple description is provided here.

In this implementation of the present application, step S603 in which the terminal generates a rule tree based on the obtained rule can include the following: determining, by the terminal, an expression and/or a logical operator for reflecting the rule based on the obtained rule; and generating, by the terminal, the rule tree based on the deterministic expression and/or logical operator.

In this implementation of the present application, a leaf node in the rule tree can be the deterministic expression, and a non-leaf node in the rule tree can be the determined logical operator.

Further, step S604 in which the terminal determines an operation result of the rule based on the rule tree and the service data can include the following: performing, by the terminal, post-order traversal on the rule tree, calculating a value of a root node in the rule tree in the post-order traversal process based on the service data, and determining a calculation result as the operation result of the rule.

Further, the service data related to the rule tree includes service data needed for calculating the expression. The calculating a value of a root node in the rule tree can include the following: calculating a value of each expression based on the obtained service data needed for calculating the expression; and calculating the value of the root node in the rule tree in the post-order traversal process based on the calculated value of each expression and the determined logical operator.

In this implementation of the present application, after the calculation result is obtained, a tracing path of the calculation result is recorded to output corresponding operation information.

In this implementation of the present application, the following step can further be performed regularly or irregularly: receiving, by the terminal, update data in the rule set from the server based on the device identifier and/or the user identifier corresponding to the terminal.

The terminal rule engine device and the terminal rule operation method provided in the implementations of the present application are described above in detail. In practice, because the rule exerts relatively huge impact on the service, security-related protective measures are adopted in a rule operation process as many as possible, to improve security, stability, and reliability of the service. The protective measures can also be used as a part of the solutions of the present application, and can include software-related or hardware-related protective measures.

For example, in terms of software, code obfuscation protection can be appropriately performed on processing logic for operating a rule. For example, protection can be performed through pack and code virtualization, or by using a code protection technology such as a sandbox.

For another example, in terms of hardware, the terminal rule engine device can be deployed or the terminal rule operation method can be used on hardware with relatively high security (for example, a trusted execution environment (TEE) or a trusted environment (TE)), to provide a more secure environment for a rule operation process.

It is worthwhile to note that the solutions of the present application have been implemented in a scenario of a risk control service, and has obtained a good effect. An operation rule is a risk control rule, and a corresponding risk control object includes a payment procedure, an authentication procedure, etc. Certainly, the solutions of the present application can also be implemented in a scenario of a service other than the risk control service, and similar results can be obtained.

A person skilled in the art should understand that an implementation of the present disclosure can be provided as a method, a system, or a computer program product. Therefore, the present disclosure can use a form of hardware only implementations, software only implementations, or implementations with a combination of software and hardware. Moreover, the present disclosure can use a form of a computer program product that is implemented on one or more computer-usable storage media (including but not limited to a disk memory, a CD-ROM, an optical memory, etc.) that include computer-usable program code.

The present disclosure is described with reference to the flowcharts and/or block diagrams of the method, the device (system), and the computer program product based on the implementations of the present disclosure. It is worthwhile to note that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate a device for implementing a specific function in one or more processes in the flowcharts and/or in one or more blocks in the block diagrams.

These computer program instructions can be stored in a computer readable memory that can instruct the computer or the another programmable data processing device to work in a specific way, so that the instructions stored in the computer readable memory generate an artifact that includes an instruction device. The instruction device implements a specific function in one or more processes in the flowcharts and/or in one or more blocks in the block diagrams.

These computer program instructions can be loaded onto the computer or another programmable data processing device, so that a series of operations and steps are performed on the computer or the another programmable device, thereby generating computer-implemented processing. As such, the instructions executed on the computer or the another programmable device provide steps for implementing a specific function in one or more processes in the flowcharts and/or in one or more blocks in the block diagrams.

In a typical configuration, a calculating device includes one or more processors (CPU), an input/output interface, a network interface, and a memory.

The memory can include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage or another magnetic storage device. The computer storage medium can be used to store information accessible by the calculating device. Based on the definition in the present specification, the computer readable medium does not include transitory computer readable media (transitory media) such as a modulated data signal and carrier.

It is worthwhile to further note that, the terms “include”, “comprise”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

The previous implementations are implementations of the present application, and are not intended to limit the present application. A person skilled in the art can make various modifications and changes to the present application. Any modification, equivalent replacement, or improvement made without departing from the spirit and principle of the present application shall fall within the scope of the claims in the present application.

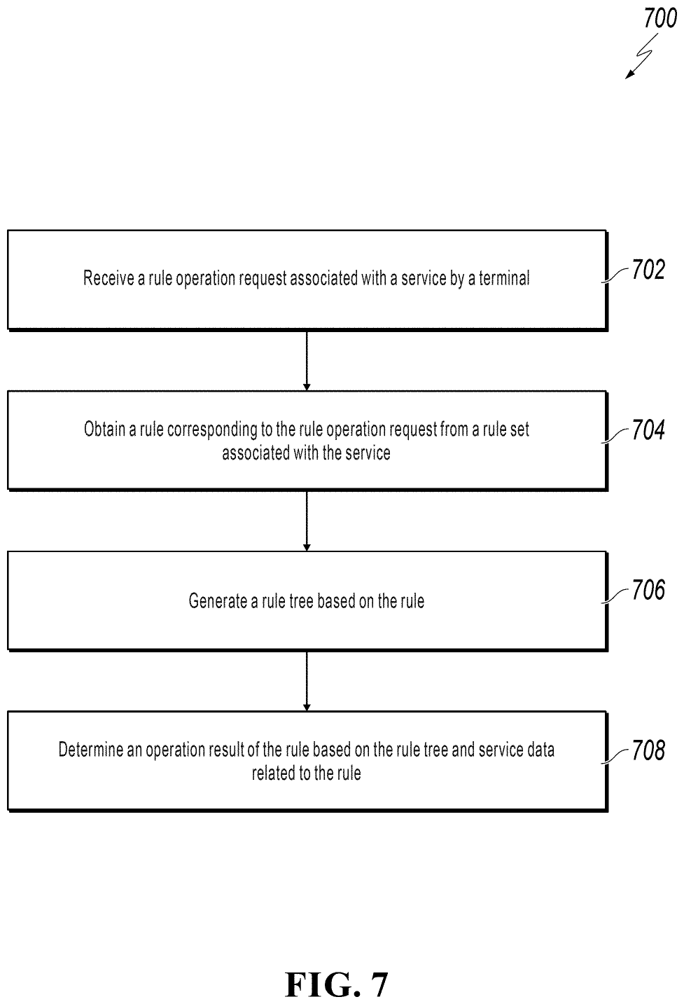

FIG. 7 is a flowchart illustrating an example of a computer-implemented method 700 for processing a rule operation, according to an implementation of the present disclosure. For clarity of presentation, the description that follows generally describes method 700 in the context of the other figures in this description. However, it will be understood that method 700 can be performed, for example, by any system, environment, software, and hardware, or a combination of systems, environments, software, and hardware, as appropriate. In some implementations, various steps of method 700 can be run in parallel, in combination, in loops, or in any order.

At 702, a rule operation request associated with a service is received by a terminal. From 702, method 700 proceeds to 704.

At 704, a rule corresponding to the rule operation request is obtained from a rule set associated with the service, wherein the rule set has been previously obtained from the server based on at least one of a device identifier or a user identifier corresponding to the terminal. From 704, method 700 proceeds to 706.

At 706, a rule tree is generated based on the rule. In some implementations, generating the rule tree based on the rule includes determining at least one of an expression and a logical operator for reflecting the rule based on the obtained rule; and generating the rule tree based on the determined at least one of the expression and the logical operator. In such implementations, the rule tree includes a leaf node and a non-leaf node, wherein the leaf node is the determined expression, and wherein the non-leaf node is the determined logical operator. From 706, method 700 proceeds to 708.

At 708, an operation result of the rule is determined based on the rule tree and service data related to the rule. In some implementations, determining the operation result of the rule includes performing a post-order traversal process on the rule tree; calculating a value of a root node associated with the rule tree based on the obtained service data; and determining, as an operation result, a calculation result of the rule. In such implementations, calculating the value of the root node includes calculating a value of each determined expression based on the obtained service data; and calculating the value of the root node based on the calculated value of each determined expression and the determined logical operator.

In some implementations, method 700 further includes recording a tracing path of the calculation result to output corresponding operation information. In some implementation, method 700 further includes obtaining updated data in the rule set from the server based on at least one of the device identifier and the user identifier corresponding to the terminal. After 708, method 700 stops.

Implementations of the present application can solve technical problems in processing rule operations, and can produce various technical effects. For example, requested rule operations can be operated on each terminal instead of the server, thereby distributing the processing burden associated with rule operations from the server to the requesting terminal. By distributing the processing burden in this way, the system as a whole may be able to process more rule operations, and thus include more terminals. In addition, this approach enables terminals to operate or execute rules independently of rules associated with other terminals, but also to perform rule operations differently from other terminals for the same service, such as based on device identifiers and/or user identifiers corresponding to the different terminals. In some implementations, the rule engine device is deployed in the terminal to manage a device-level rule set and/or a user level rule set by using the device identifier and/or the user identifier of the terminal. Therefore, a rule in the rule set is operated in the terminal, and rule operation or rule update is separately performed in different terminals, to reduce the risk of data loss during rule operation or rule update, thereby partially or totally alleviating the problem of the high risk in the existing technology.

Further, because the operation of a rule by one terminals does not affect other terminals, the stability of the system as a whole and its resilience to errors encountered when performing rule operations can be improved. For example, a rule operation result of each terminal affects only the terminal. Therefore, even if an unreliable rule operation result is obtained by one terminal, it does not affect the other terminals. Third, operating the rule in the form of the rule tree also brings additional advantages. For example, because the structure of the rule tree is hierarchical, orderly, and visible, and is easy to split, it becomes simpler to logically manage, analyze, and adjust a rule, thereby improving R&D and O&M efficiency and reducing R&D and O&M costs.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
receiving, by a terminal, a rule operation request associated with a service;
obtaining, by the terminal, a rule corresponding to the rule operation request from a rule set associated with the service, wherein the rule set has been previously obtained from a server based on at least one of a device identifier or a user identifier corresponding to the terminal;
generating, by the terminal, a rule tree based on the rule;
determining, by the terminal, an operation result of the rule based on the rule tree and service data related to the rule.

2. The computer-implemented method of claim 1, wherein generating the rule tree based on the rule includes:
determining at least one of an expression and a logical operator for reflecting the rule based on the obtained rule; and
generating the rule tree based on the determined at least one of the expression and the logical operator.

3. The computer-implemented method of claim 2, wherein the rule tree includes a leaf node and a non-leaf node, wherein the leaf node is the determined expression, and wherein the non-leaf node is the determined logical operator.

4. The computer-implemented method of claim 1, wherein determining the operation result of the rule includes:
performing a post-order traversal process on the rule tree;
calculating a value of a root node associated with the rule tree based on the obtained service data; and
determining as an operation result, a calculation result of the rule.

5. The computer-implemented method of claim 4, wherein calculating the value of the root node includes:
calculating a value of each determined expression based on the obtained service data; and
calculating the value of the root node based on the calculated value of each determined expression and the determined logical operator.

6. The computer-implemented method of claim 4, further comprising:
recording a tracing path of the calculation result to output corresponding operation information.

7. The computer-implemented method of claim 1, further comprising:
obtaining updated data in the rule set from the server based on at least one of the device identifier and the user identifier corresponding to the terminal.

8. A non-transitory, computer-readable medium storing one or more instructions executable by a computer system to perform operations comprising:
receiving, by a terminal, a rule operation request associated with a service;
obtaining, by the terminal, a rule corresponding to the rule operation request from a rule set associated with the service, wherein the rule set has been previously obtained from a server based on at least one of a device identifier or a user identifier corresponding to the terminal;
generating, by the terminal, a rule tree based on the rule;
determining, by the terminal, an operation result of the rule based on the rule tree and service data related to the rule.

9. The non-transitory, computer-readable medium of claim 8, wherein generating the rule tree based on the rule includes:
determining at least one of an expression and a logical operator for reflecting the rule based on the obtained rule; and
generating the rule tree based on the determined at least one of the expression and the logical operator.

10. The non-transitory, computer-readable medium of claim 9, wherein the rule tree includes a leaf node and a non-leaf node, wherein the leaf node is the determined expression, and wherein the non-leaf node is the determined logical operator.

11. The non-transitory, computer-readable medium of claim 8, wherein determining the operation result of the rule includes:
performing a post-order traversal process on the rule tree;
calculating a value of a root node associated with the rule tree based on the obtained service data; and
determining as an operation result, a calculation result of the rule.

12. The non-transitory, computer-readable medium of claim 11, wherein calculating the value of the root node includes:
calculating a value of each determined expression based on the obtained service data; and
calculating the value of the root node based on the calculated value of each determined expression and the determined logical operator.

13. The non-transitory, computer-readable medium of claim 11, the operations further comprising:
recording a tracing path of the calculation result to output corresponding operation information.

14. The non-transitory, computer-readable medium of claim 13, the operations further comprising:
obtaining updated data in the rule set from the server based on at least one of the device identifier and the user identifier corresponding to the terminal.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a terminal, a rule operation request associated with a service;
obtaining, by the terminal, a rule corresponding to the rule operation request from a rule set associated with the service, wherein the rule set has been previously obtained from a server based on at least one of a device identifier or a user identifier corresponding to the terminal;
generating, by the terminal, a rule tree based on the rule;
determining, by the terminal, an operation result of the rule based on the rule tree and service data related to the rule.

16. The computer-implemented system of claim 15, wherein generating the rule tree based on the rule includes:
determining at least one of an expression and a logical operator for reflecting the rule based on the obtained rule; and
generating the rule tree based on the determined at least one of the expression and the logical operator.

17. The computer-implemented system of claim 16, wherein the rule tree includes a leaf node and a non-leaf node, wherein the leaf node is the determined expression, and wherein the non-leaf node is the determined logical operator.

18. The computer-implemented system of claim 15, wherein determining the operation result of the rule includes:
performing a post-order traversal process on the rule tree;
calculating a value of a root node associated with the rule tree based on the obtained service data; and
determining as an operation result, a calculation result of the rule.

19. The computer-implemented system of claim 18, wherein calculating the value of the root node includes:
calculating a value of each determined expression based on the obtained service data; and
calculating the value of the root node based on the calculated value of each determined expression and the determined logical operator.

20. The computer-implemented system of claim 18, the operations further comprising:
recording a tracing path of the calculation result to output corresponding operation information.
